(19) United States
(12) Patent Application Publication
(10) Pub. No.: US 2013/0226965 A1
(43) Pub. Date: Aug. 29, 2013

(54) Acquiring Customized Information from a Server

(71) Applicant: International Business Machines Corporation, (US)

(72) Inventors: Yuto Fukui, Tokyo (JP); Sanehiro Furuichi, Tokyo (JP); Tomohiro Shioya, Tokyo (JP); Masami Tada, Tokyo (JP)

(73) Assignee: INTERNATIONAL BUSINESS MACHINES CORPORATION, Armonk, NY (US)

(21) Appl. No.: 13/674,537

(22) Filed: Nov. 12, 2012

(30) Foreign Application Priority Data
Feb. 29, 2012 (JP) 2012-042652

(51) Int. Cl. G06F 17/30

(52) U.S. Cl. CPC G06F 17/30554
USPC 707/770

(57) ABSTRACT

A mechanism is provided for acquiring information from a server based on search condition input by a search performing user and communication results with other information terminals. Input search conditions are received from a search performing user. Communication is performed with other information terminals. A search request is transmitted to the server based on the input search conditions and the communication results from the other information terminals. Information is received from the server that matches input search results and the communication results. The acquired information is customized based the communication results with the other information terminals. The customized information is then displayed on the information terminal.

### BACKGROUND

The present invention relates to acquiring customized information from a server.

A search method is known that searches a website from a terminal based on search keywords or the like, and prioritizes and displays the search results (for example, refer to Japanese Unexamined Patent Application No. 2004-272492.

However, conventionally, it was not possible to obtain search results that were customized to match the preferences and status of a plurality of users.

### SUMMARY

In one illustrative embodiment, a method, in a data processing system, is provided for acquiring information from a server based on search condition input by a search performing user and communication results with other information terminals. The illustrative embodiment receives input search conditions from the search performing user. The illustrative embodiment communicates with other information terminals. The illustrative embodiment transmits a search request to the server based on the input search conditions and the communication results with the other information terminals. The illustrative embodiment acquires information from the server that matches the input search conditions and the communication results. The illustrative embodiment customize the acquired information based the communication results with the other information terminals to form customized information. The illustrative embodiment displays the customized information on the information terminal.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, an information terminal system is provided. The information terminal system may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention. It should be noted that the above summary of the invention is not intended to enumerate all of the features required of the present invention. Furthermore, it is also possible to have inventions with subcombinations of these characteristics.

### BRIEF DESCRIPTION OF THE SEVERAL VIEWS OF THE DRAWINGS

FIG. 1 illustrates an outline of an information system 10 according to an embodiment of the present invention;

FIG. 2 illustrates a specific structure of an information system 10 according to an embodiment of the present invention;

FIG. 3 expresses a process flow for an embodiment of the present invention;

FIG. 4 illustrates a process flow for an embodiment of the present invention;

FIG. 5 expresses a process flow for an embodiment of the present invention;

FIG. 6 illustrates an example of a retail establishment search using an information system according to an embodiment of the present invention;

FIG. 7 illustrates another example of a retail establishment search using an information system according to an embodiment of the present invention;

FIG. 8 illustrates an example of a transportation route search using an information system according to an embodiment of the present invention;

FIG. 9 illustrates a specific structure of an information system according to a first alternate example of an embodiment of the present invention;

FIG. 10 illustrates a process flow for a first alternate example of an embodiment of the present invention;

FIG. 11 illustrates a process flow for a first alternate example of an embodiment of the present invention;

FIG. 12 expresses a process flow for a first alternate example of an embodiment of the present invention;

FIG. 13 illustrates a specific structure of an information system according to a second alternate example of an embodiment of the present invention;

FIG. 14 illustrates a process flow for a second alternate example of an embodiment of the present invention;

FIG. 15 illustrates a process flow for a second alternate example of an embodiment of the present invention;

FIG. 16 expresses a process flow for a second alternate example of an embodiment of the present invention;

FIG. 17 illustrates an outline of an information system according to a third alternate example of an embodiment of the present invention;

FIG. 18 illustrates a specific structure of an information system according to a third alternate example of an embodiment of the present invention;

FIG. 19 illustrates a process flow for a third alternate example of an embodiment of the present invention;

FIG. 20 illustrates a process flow for a third alternate example of an embodiment of the present invention;

FIG. 21 expresses a process flow for a third alternate example of an embodiment of the present invention; and

FIG. 22 illustrates an example of a hardware configuration of the computer that can be used as the information terminal and the server and the like.

### DETAILED DESCRIPTION

The present invention is described below using embodiments of the invention, but the following embodiments do not limit the invention according to the patent claims. Furthermore, all combinations of characteristics described in the embodiments are not necessarily essential to the resolution means of the present invention.

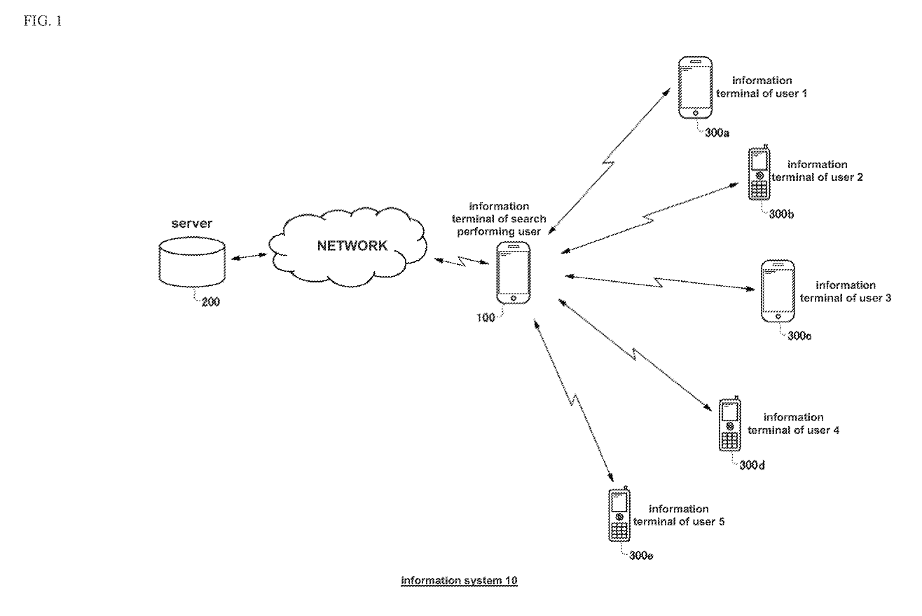

FIG. 1 illustrates an outline of an information system 10 according to an embodiment of the present invention. The information system 10 matches search conditions and displays to the user search results that have been customized based on the attribute information of the user. The information system 10 contains an information terminal 100 of a search performing user that performs a search, a server 200, and information terminals 300a, 300b, 300c, 300d, 300e of one or a plurality of other users 1 through 5. The information terminal 100 and the like can be an electronic device such as a mobile phone terminal, mobile information terminal, personal computer, or the like. The information terminals 300a through 300e of the other users 1 to 5 can be located in proximity to the information terminal 100, and in this case, can communicate with the information terminal 100 by short distance communication.

The information terminal 100 of the search performing user acquires information from the server 200 based on search results input from the search performing user. More specifically, the information terminal 100 communicates with the information terminals 300a through 300e of the other users, and acquires communication results that include attribute information such as the number of other users 1 through 5 and/or the eating preferences of the other users 1 through 5. The information terminal 100 of the search performing user transmits via a network to the server 200 performing the search a search request based on the search conditions and communication results with the other information terminals 300a and the like.

The server 200 is a search server that receives a search request from an information terminal 100 and searches the information of various Web servers on the Internet or database, searches the customized information based on the search conditions from the information terminal 100, and transmits to the information terminal 100. The information terminal 100 acquires customized information from the server 200 and displays to the search performing user, and also transmits to the other information terminals 300a through 300e. This type of information system 10 can provide customized search results based on communication results between and information terminal 100 and other information terminals 300a and the like.

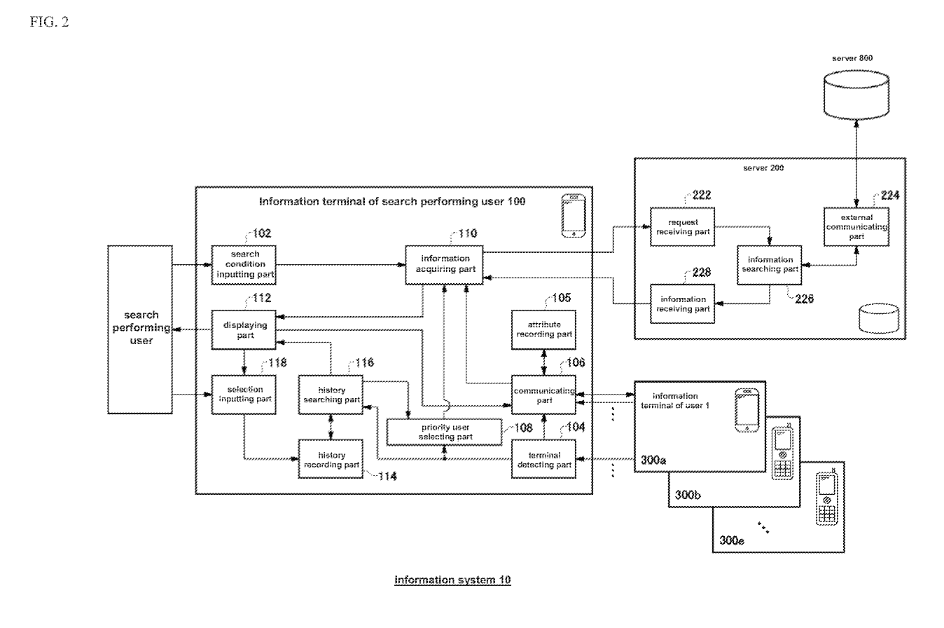

FIG. 2 illustrates a specific structure of an information system 10 according to an embodiment of the present invention. The information terminal 100 contains a search condition input part 102, terminal detecting part 104, attribute recording part 105, communicating part 106, priority user selecting part 108, information acquiring part 110, display part 112, history recording part 114, history searching part 116, and selection inputting part 118.

The search condition inputting part 102 includes a keyboard and/or touch panel or the like, and inputs search conditions from the search performing user. The search condition inputting part 102 inputs search conditions as conditions for searching services, products, stores, people, information, and/or other data desired by the search performing user from a database and/or Internet Web server. For example, the search condition inputting part 102 may input search conditions as conditions for searching stores or conditions for searching transportation routes. The search condition inputting part 102 provides the input search conditions to the information acquiring part 110.

The terminal detecting part 104 detects other information terminals 300a through 300e that are subject to acquisition of attribute information. The terminal detecting part 104 provides information for identifying the other information terminals 300a through 300e that were detected to the communicating part 106, priority user selecting part 108, and history searching part 116.

The attribute recording part 105 preliminarily records attribute information of the user of the information terminal 100. The attribute recording part 105 provides the attribute information of the search performing user to the communicating part 106.

The communicating part 106 communicates with the one or plurality of other information terminals 300a through 300e that were detected by the terminal detecting part 104, and receives attribute information for the users of each information terminal from the information terminals 300a through 300e.

The communicating part 106 may communicate with the other information terminals 300a through 300e by near distance communication if the other information terminals 300a through 300e are located in proximity. Proximity refers to a range where communicating by near distance communication is possible, and for example may be a range where the users can converse together. Furthermore, the communicating part 106 can use communication that directly transfers data between information terminals without passing through a base station, or can use communication that transfers data through one base station, or can use wireless communication such as a wireless LAN, wireless PAN, or infrared communication, or can use wire communication through a cable or the like.

In place of acquiring the attribute information by near distance communication, the communicating part 106 can acquire from the other information terminals 300a through 300e user identifying information that the user of each information terminal uses on the Internet, search the server 200 on the network or other server using the user identifying information, and thereby acquire the user attribute information of the other information terminals that are publicly made known on the Internet. User identifying information refers to information or the like on the user that can be acquired by a search engine or the like and account information of a social networking service (SNS) of the user, or an address of the homepage or blog or the like of the user.

The communicating part 106 provides the result of communicating with the other information terminals 300a through 300e to the information acquiring part 110. The communication result is information that the information terminal 100 can acquire by communication or as a result of communicating with the other information terminals 300a through 300e, and can also be user attribute information of the other information terminals 300a through 300e or the number of other information terminals 300a through 300e that were detected by the terminal detecting part 104.

The communicating part 106 can also acquire attribute information of the search performing user from the attribute recording part 105 in addition to the attribute information of the users of the other information terminals 300a through 300e, and can provide communication results including the attribute information of the search performing user to the information acquiring part 110. Furthermore, the communicating part 106 can acquire current position information and/or movement information of the information terminal 100 from a GPS and/or accelerometer sensor or the like provided in the information terminal 100, and can provide this information to the information acquiring part 110 as attribute information of the information terminal 100.

The communicating part 106 can transmit information acquired from the server 200 and displayed by the displaying part 112 to the other information terminals 300a through 300e and cause the information to be displayed.

The priority user selecting part 108 acquires information of the other information terminals 300a through 300e from the terminal detecting part 104, and selects whether or not each user has priority over the various users of the information terminals 300a through 300e that are in communication. The priority user selecting part 108 preliminarily records the identifying information of the priority users that have priority during searching, and selects the priority users by selecting users that match the identifying information preliminarily recorded from among the users of the plurality of other information terminals 300a through 300e. The priority user selecting part 108 can record specific users that were identified by the history searching part 116 as priority users. The priority user selecting part 108 provides information related to the information acquiring part 110.

The information acquiring part 110 transmits search request based on search conditions and communication results with the other information terminals 300a through 300e to the server 200 via a network such as the Internet or the like. When the information acquiring part 110 receives information related to the priority user, the information acquiring part 110 can transmit the information related to the priority user along with the result of communicating with the other information terminals 300a through 300e to the server 200.

After the server 200 has performed a search, the information acquiring part 110 acquires one or a plurality of information customized based on matching the search conditions and the result of communicating with the other information terminals 300a through 300e. The information acquiring part 110 transfers the information acquired from the server 200 to the displaying part 112. Furthermore, the information acquiring part 110 can provide the information of the other information terminals 300a through 300e that were detected to the displaying part 112.

The displaying part 112 displays one or a plurality of customized information acquired from the information acquiring part 110 on a display device such as a liquid crystal display. For example, the displaying part 112 displays an estimated value for the degree of satisfaction of the search performing user and users of other information terminals with regards to the information included in the search results.

Instead of displaying a plurality of customized information acquired from the information acquiring part 110 as is, the displaying part can display further customized information based on a history of information selected from the acquired information by the search performing user in the past. For example, the displaying part 112 displays customized information that does or does not prioritize stores selected in the past, or can display customized information that prioritizes a transportation route that has been selected in the past. The displaying part 112 may transfer the customized information to the communicating part 106 to provide to the other information terminals 300a through 300e. The displaying part provides one or a plurality of customized information together with the information of the other information terminals 300a through 300e to the selection inputting part 118.

The history recording part 114 records the history of information selected by the search performing user from a plurality of information displayed by the displaying part 112. The history recording part 114 may also assign and record a history of the selected information to a user group of the users detected by the terminal detecting part 104 when searching, including the users of the plurality of other information terminals 300a through 300e.

The history searching part 116 searches the history of information selected in the past by the search performing user from the history recording part 114. For example, if the information system 10 performs a search of stores, the history searching part 116 searches the history of stores that were selected from search results in the past by the search performing user.

Furthermore, the history searching part 116 may also search the history recording part 114 for the history of information for a user group that is identical or similar to a user group that includes the users of the other information terminals 300a through 300e that were detected by the terminal detecting part 104 during this information acquisition. For example, if the search performing user performs a retail establishment search together with users 1 through 5, the history searching part 116 will search the history recording part 114 for retail establishment information corresponding to the user group that includes the users 1 through 5 or similar user group, from the stores selected in the past by the search performing user.

The history searching part 116 may also detect the history of information corresponding to the user group that includes the users of this information acquisition from the history recording part 114, and provides the specific user information to the priority user selecting part 108 if the frequency of selecting information with the highest degree of satisfaction by a specific user in a user group in the history is above a fixed threshold value.

The history searching part 116 provides the results of searching the history recording part 114 to the displaying part 112.

Therefore, the displaying part 112 can further customize and display information based on the history selected in the past by the user group that includes the user performing the current search as well as by the search performing user.

The selection inputting part 118 inputs the information selected by the search performing user from a plurality of information which are the search results displayed by the displaying part 112. The selection displaying part 118 provide the customized information that was acquired from the displaying part 112 and the information selected by the user to the history recording part 114. Furthermore, the selection inputting part 118 may also record beforehand user information that defines the user group, and provide the information selected by the search requesting user to the history recording part 114 corresponding to the users of the other information terminals 300a through 300e that were selected and/or a user group that includes these users.

The server 200 receives the search request from the information terminal 100 via a network, matches the search request, and returns to the information terminal 100 the customized information corresponding to the communication results between the information terminal 100 and the other information terminals 300a through 300e. The server 200 includes a request receiving part 222, external device communicating part 224, information searching part 226, and information transmitting part 228.

The request receiving part 222 receives the search request and the attribute information of the search performing user and the other users 1 through 5 from the information acquiring part 110 of the information terminal 100 of the search performing user. The request receiving part 222 provides the search request and the attribute information that was received to the information searching part 226. The external device communicating part 224 communicates with an external server 800 through a network.

The information searching part 226 compares to the search conditions specified in the search request, based on the search request and the attribute information of the search performing user and the other users, and searches the information that has been customized based on the attribute information of the search performing user and other users and/or the number of other information terminals and the like.

For example, the information searching part 226 searches a database or the like stored on the server 800, compares to the search conditions, and searches information such as a plurality of eating and drinking establishments. The information searching part 226 customizes the information for the plurality of stores so as to omit a portion of the information of the plurality of stores that matches a search condition such that stores with a genre that the user has an eating allergy towards are not included, based on the attribute information for the preferences of foods by each user. The information detecting part 226 transmits one or a plurality of customized information to the information transmitting part 228.

The information transmitting part 228 acquires the customized information from the information searching part 226, and transmits the acquired information through a network to the communicating part of the information terminal 100 of the search performing user. In addition, the information transmitting part 228 may also transmit the acquired information to the information terminals 300a through 300e of the other users 1 through 5.

The information terminals 300a through 300e may have an identical configuration to the information terminal 100 of the search performing user. The information terminals of bowl of the other users 1 through 5 receives a request from the communicating part 106 of the information terminal 100 and transmit attribute information of the user to the communicating part 106 of the information terminal 100. In this case, the attribute recording part 105 of the other information terminals 300a through 300e provides the attribute information of the users to the communicating part 106 of the other information terminals, and the communicating part 106 of the other information terminals transmits the attribute information of each user to the communicating part 106 of the information terminal 100.

Furthermore, the information terminals 300a through 300e may also perform customize searches instead of the information terminal 100. In this case, the communicating part 106 of the information terminal 100 receives a request for attribute information from the other information terminals 300a through 300e, acquires user attribute information of the information terminal 100 from the attribute recording part 105 and provides the acquired attribute information to the communicating part 106 of the other information terminals. Thereby, the information terminal 100 can perform a customize search of the other information terminals 300a through 300e based on the attribute information of the user of the information terminal 100.

In this manner, the information system 10 can perform customize searches based on the attribute information of the search performing user and the other users, and can obtain search results that are optimized for the user group. Therefore, with the information system 10, the search performing user is not required to select information of search results that independently consider the information of other users and the like.

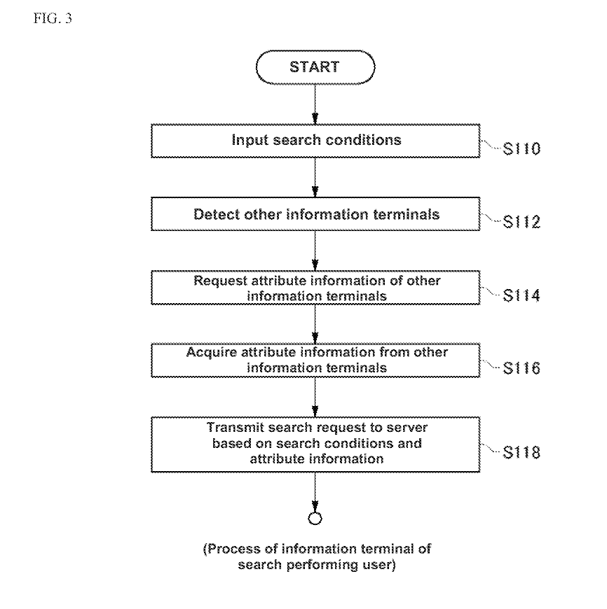

FIG. 3 through FIG. 5 illustrates the process flow of an information system 10 according to an embodiment of the present invention. With the embodiment of the present invention, the information terminal 100 transmit the search conditions and the communication results with other information terminals to the server 200, and then the server 200 returns to the information terminal 100 the customized information that matches the search results and corresponds to the communication results, and the information terminal of the search performing user further customizes the acquired information based on the history. The information system 10 performs a customized search by the processes of S110 through S138.

FIG. 3 illustrates the process flow of the embodiment of the present invention performed by the information terminal 100 of the search performing user.

First, in S110, the search condition inputting part 102 of the information terminal 100 inputs the search conditions such as stores or transportation route or the like from the search performing user via a keyboard or touch panel or the like. The stores which are the search subject include eating and drinking establishments such as restaurants, retail stores such as department stores, and leisure facilities such as karaoke establishments and sports shops and the like. When searching stores, the search conditions may include the retail establishment location or region, genre, operating hours, and budget or the like.

The transportation routes that are subject to search include for example various types of transportation means such as airplanes, trains, buses, taxis and the like for transporting from a specified departure to a destination by a specified time or time period, the closest train station or the like, the railroad that is used, junction stations and the like, transportation paths, transportation time, and the like. When searching transportation routes, the search conditions may also include departure location, arrival location, fares, required time, arrival time, and the like. The search condition inputting part 102 provides the input search conditions to the information acquiring part 110.

Next, in S112, the terminal detecting part 104 detects other information terminals 300a through 300e of the other users 1 through 5 that are subject to acquisition of attribute information. For example, the terminal detecting part 104 detects the other information terminals 300a through 300e that can communicate with the information terminal 100 through a network or by near distance communication, receives identifying information such as the username, phone number, mail address, or contractor unique identifying number, and detects the other information terminals 300a through 300e of users 1 through 5.

Alternatively, the terminal detecting part 104 may also detect the other information terminals 300a through 300e based on location information and/or movement information. Specifically, the information terminal 100 of the search performing user and the information terminals 300a through 300e of the other users transmit coordinate information of the information terminal acquired from GPS or the like and/or one or more of the movement direction, movement speed, or acceleration information acquired from an accelerometer sensor, along with the identifying information of the information terminal 100 to the server 200 or other server. The server 200 transmits to the terminal detecting part 104 of the information terminal 100 of the search performing user the identifying information and the like of the information terminals where a predetermined motion was detected at a specified time and/or the information terminals that exist within a specified distance from the information terminal 100 that is performing the search operation.

Thereby, the terminal detecting part 104 can acquire identifying information of the information terminals 300a through 300e all other users through the server 200 or another server, either by the search performing user pressing a search button of the information terminal 100 while the information terminal 100 and the other information terminals 300a through 300e are in proximity, or by the search performing user performing an operation such as placing the information terminal 100 and the other information terminals 300a through 300e in a bag or the like and shaking together.

Alternatively, the terminal detecting part 104 may also detect the other information terminals 1 through 5 using an audible sound or an infrared signal. For example, the terminal detecting part 104 transmit a preestablished audible signal or infrared signal to the other information terminals 300a through 300e. When the other information terminals 300a through 300e received the preestablished audible signal or infrared signal, the identifying information of the information terminal is transmitted to the server 200 or other server. The server 200 or the like transmits the number of information terminals that received audible signals or the like and the identifying information or the like to the terminal detecting part 104 of the information terminals 100. The terminal detecting part 104 may also provide information for identifying the other information terminals 300a through 300e that was acquired to the communicating part 106, priority user selecting part 108, and history searching part 116.

The priority user selecting part 108 selects priority users with priority from the users of the plurality of other information terminals 300a through 300e. For example, the priority user selecting part 108 selects as priority users those users that match with identifying information recorded beforehand, from the users of the information terminals 300a through 300e that were detected. The priority user selecting part 108 may also transmit information related to the information acquiring part 110.

Next, in S114, the communicating part 106 communicates by near distance communication or the like with one or a plurality of other information terminals 300a through 300e and requests attribute information for each of the users of the information terminals 300a through 300e. The attribute information may include for example all or a portion of information related to (1) personal information such as user birthdate, gender, employment, address, employer address, title, race, and/or birthplace or the like, (2) historical information such as occupational and educational history of the user and/or qualifications and the like, (3) human related information such as family relationships, superiors, subordinates, and peer relationships at the workplace and/or hiring the related information and the like, (4) body information of the user such as the height, weight, stature, physical characteristics, health condition, physical or mental handicaps, smoking record, and/or allergies and the like (5) preference information of the user such as food preference, preference of alcohol, religion, and/or beliefs and the like; (6) Internet information such as SNS account information, SNS human relationships, SNS communities and/or information related to the user that is disclosed on the Internet, (7) real-time information such as the current position of the user and the like, (8) search history information such as the information search history of the user and the like, (9) setting information such as the settings by the user for the aforementioned (1) through (8), and/or (10) other information related to the user.

Next, in step S116, the communicating part 106 acquires attribute information of the other users from the other information terminals 300a through 300e detected in S114. For example, communicating part 106 retrieves as attribute information the information including either the address or current location of the users of the other information terminals 300a through 300e from the other information terminals 300a through 300e. Furthermore, the communicating part 106 retrieves the attribute information of the search performing user from the attribute recording part 105. The communicating part 106 provides the attribute information of the search performing user and other users that was acquired and/or the number of other information terminals, as communication results with the other information terminal 300a and the like.

Next, in S118, the information acquiring part 110 transmits a search request including communication results that were acquired from the communicating part 106 and search conditions acquired from the search condition inputting part 102 to the server 200. Herein, the information acquiring part 110 can transmit the user attribute information related to the search conditions from the communication results to the server 200. For example, if the search conditions are conditions for searching a retail establishment, the communicating part 106 can transmit the attribute information related to the food preferences, food allergies, religion (such as Islam or Hinduism) and beliefs (such as vegetarian) to the other information terminals 300a through 300e. Furthermore, the information acquiring part 110 can transmit information related to a priority user along with the attribute information to the request receiving part 222 of this server 200.

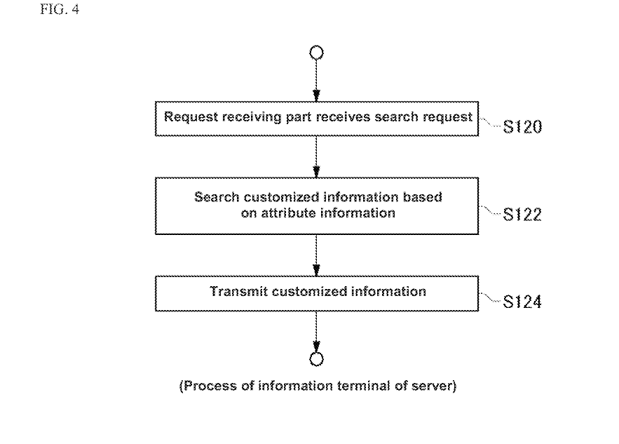

FIG. 4 illustrates the process flow for an embodiment of the present invention that is performed by the server 200 after S118. In S120, the request receiving part 222 of the server 200 receives a search request from the information acquiring part 110 of the information terminal 100, attribute information of the search performing user and other users, and communication results including the number of other information terminals, as well as information related to a priority user. The request receiving part 222 provides the search request that was received to the information searching part 226.

Next, in S122, the information searching part 226 communicates with an external server 800 via an external device communicating part 224, compares to the search conditions specified in the search request, based on the search request and communication results such as the attribute information of the search performing user and the other users, and searches the information that has been customized based on the attribute information of the search performing user and other users.

Herein, the term “match to search conditions” complete matching of search conditions and the partial matching of search conditions. The term “search customized information” refers to processing one or a plurality of information that matches search conditions, and for example, can be a change to the degree of priority or order of priority of information, omitting a portion of the information, or attaching additional information such as the degree of satisfaction of the user to the information.

For example, the information searching part 226 can change the order for displaying the searched information based on the attribute information of the search performing user and other users and/or the number of other information terminals. For example, the information searching part 226 can calculate an estimated value for the overall degree of satisfaction by all users including the search performing user and the other users based on the attribute information of the users, and change the order of a plurality of information detected so as to arrange information in order of the highest expected value for the degree of satisfaction.

For example, if the search conditions are conditions for searching restaurants or the like, the information searching part 226 may omit a portion of the restaurant information and/or may change the order of the plurality of restaurant information that was found, based on the attribute information including the food allergies of the users, food preferences, and smoking preference. Furthermore, the information searching part 226 can eliminate small-scale restaurant information with fewer seats than the total number of users including the search performing user, and/or change the order of a plurality of restaurant information that was found in order of the highest number of seats, based on the number of other information terminals.

Furthermore, the information detecting part 226 can search and customize information on restaurants or the like based on attribute information that includes the address and/or current location of the search performing user and other users. For example, the information searching part 226 can search for restaurants where the travel time, arrival time, travel distance, or travel fares from the locations of all users are essentially equal for all of the users, and arrange the information of restaurants or the like based on these conditions.

Furthermore, the information searching part 226 can customize information for restaurants and the like based on the address and the operating hours of the restaurant or the like and the address of all users. For example, the information searching part 226 can search for restaurants or the like where all users can arrive more than a predetermined time before the operation closing time of the restaurant, calculate the time that users can stay in the restaurant or the like until the final departing train time for the railroads that are included in the return path of all users, and can arrange the restaurant information in the order that all users can stay at the restaurant the longest.

Furthermore, if for example the search conditions are conditions for searching the transportation route, the information detecting part 226 calculates the transportation fares while considering the use of taxis as well as multiple ride tickets and group fares, based on the number of other information terminals. The information detecting part 226 can arrange the order of the transportation route information that was detected in order of the cheapest calculated transportation fares. Furthermore, alternatively, the information searching part 226 can search transportation routes so that all of the plurality of users travel on the same route, or on different routes

Furthermore, the information detecting part displays the customized search results that have multiple selected users as priority users of all users. Furthermore, the information searching part 226 can customize information with a particular focus on duplicate attribute information if the attribute information of a plurality of users is duplicated. The information detecting part 226 transmits the customized information to the information transmitting part 228.

Next, in S124, the information transmitting part 228 acquires the customized information from the information searching part 226, and transmits the acquired information through a network to the communicating part of the information terminal 100 of the search performing user. Alternatively, or in addition, the information transmitting part 228 may transmit the acquired information to the other information terminals 300a through 300e through a network.

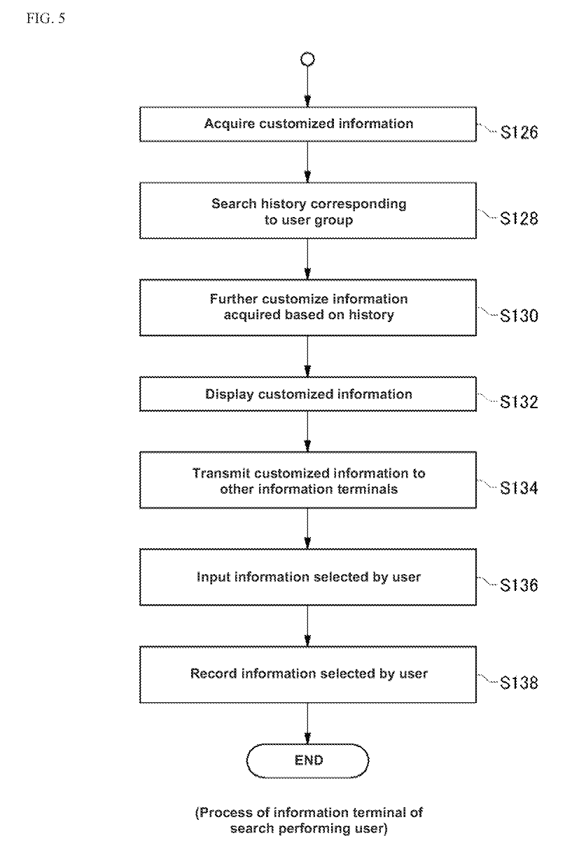

FIG. 5 illustrates the process flow of the embodiment of the present invention performed after S124 by the information terminal 100 of the search performing user. In S126, the information acquiring part 110 of the information terminal 100 acquires information that has been searched and customized by the server 200.

If the search conditions are conditioned for searching retail establishments, the information acquiring part 110 acquires information related to the retail establishments from the server 200, and if the search conditions are conditions for searching a transportation route, the information acquiring part 110 acquires the information related to the transportation route from the server 200. The customized information can be for example information that includes the estimated value for the degree of satisfaction of the search performing user and the users of the other information terminals 300a through 300e with regards to the search results for the search conditions. Furthermore, the information acquiring part 110 can match the search conditions, prioritize the attribute information of the priority users based on the communication results, and acquire customized information from the server 200. Furthermore, the information acquiring part 110 can provide the information of the other information terminals 300a through 300e that were detected to the displaying part 112.

Next, in S128, the history searching part 116 may also search the history recording part 114 for the history of information for a user group that is identical or similar to a user group that includes the users of the other information terminals 300a and the like that were detected by the terminal detecting part 104 in S112. For example, if the search conditions are conditions for searching a retail establishment, and if the other information terminals belong to a user group of “peers of the search performing user”, the history searching part 116 will detect the history of retail establishments that were searched and selected in the past by the search performing user and the “peers of the search performing user”, from the history recording part 114.

The history searching part 116 provide historical information to the displaying part 112.

Next, in S130, the displaying part 112 further customizes the plurality of customized information received from the information acquiring part 110, based on the historical information received from the history searching part 116. For example, if the search conditions are conditions for searching a retail establishment, the displaying part 112 can customize the information so that retail establishments that have been repeatedly visited in the past by the user group will be higher level search results during the current information acquisition. Alternatively, the displaying part 112 can customize the information so as to eliminate these retail establishments from the search results. Furthermore, the displaying part 112 provides one or a plurality of acquired information together with the information of the other information terminals 300a through 300e to the selection inputting part 118.

Next, in S132, the displaying part 112 displays the customized information. The displaying part 112 transmits the customized information to the communicating part 106. Herein, the information terminal 100 can also receive a request to return the process to S110. Thereby, the search performing user can continue to search using more suitable search conditions if the information displayed on the displaying part 112 is unsatisfactory. Note, when the process returns to S110, the information terminal 100 can omit processes S114 and S116.

Next, in S134, the communicating part 106 transmits information customized by the displaying part 112 to the other information terminals 300a through 300e. Note, in S124, the information transmitting part 228 of the server 200 can omit the process of S134 if the information acquired from the other information terminals 300a through 300e has been transmitted.

Next, in S136, the selection inputting part 118 inputs the information selected by the search performing user from a plurality of information that are provided by the displaying part 112. Herein, the selection inputting part 118 records the response of the user group and the users that are included in the user group, and if a user group that includes the users of the other information terminals 300a through 300e or a similar users group are recorded, the information that was selected in response to the recorded user group will be input.

The selection inputting part 118 can acquire information that was directly input by the search performing user using a user interface. Alternatively, the selection inputting part 118 can also acquire information that was selected by the search performing user from the transportation information of the information terminal 100.

For example, if the selection inputting part 118 acquires position information of the information terminal 100 from a GPS or the like, the address information of a plurality of retail establishments provided by the displaying part 112 will be compared to the location of the information terminal 100. If the position of the information terminal 100 is present for a fixed period of time in the location of any other plurality of retail establishments, the selection inputting part 118 can determine if the information that was selected by the search performing user is the information for that retail establishment.

Furthermore, alternatively, the selection inputting part 118 can also acquire information that was selected by the search performing user from the status of coupons used by the search performing user. For example, for the case of searching restaurants, the displaying part 112 displays information of discount coupons or the like with identifying information that can be used at restaurants along with the information of a plurality of restaurants in S132. When the search performing user uses a coupon at a restaurant, the identifying information of the coupon is transmitted to an external server or the like, and the history of using the coupon is recorded in the external server or the like. Herein, the selection inputting part 118 can acquire the information of the restaurants that have been selected by the search performing user by acquiring information on the coupons that have been used from the external server or the like.

Next, in S138, the history recording part 114 acquires and records the information selected by the search performing user from the selection inputting part 118. The history recording part 114 records the information that was selected by the search requesting user corresponding to the user group.

In this manner, the information system of the embodiment of the present invention causes the server 200 to match search conditions and search for information that is being customized based on attribute information from a plurality of users, and can further customize the information based on the history of the information terminal 100. Thereby, the information system 10 can provide optimized search results to a plurality of users that are jointly performing a search.

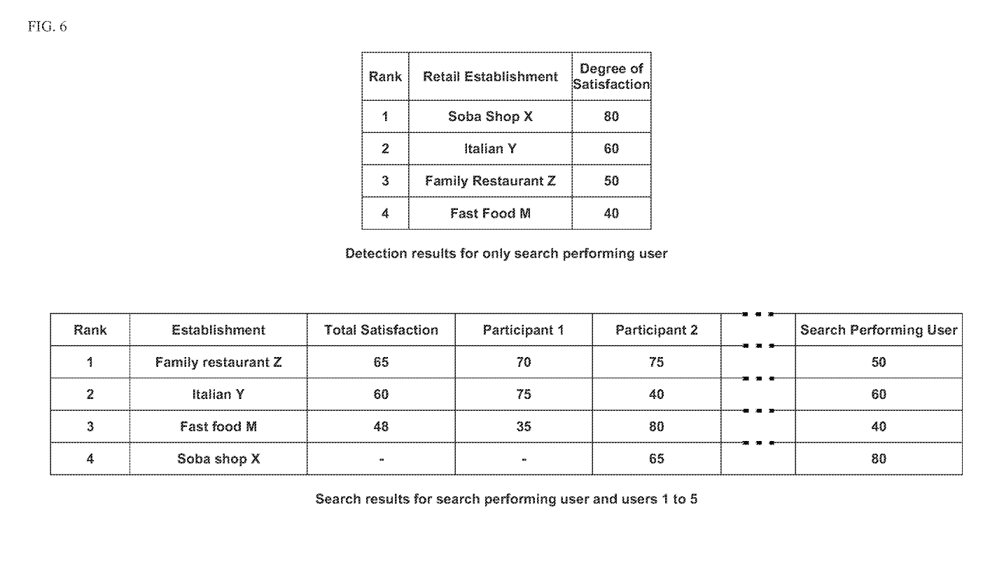

FIG. 6 illustrates an example of a retail establishment search using an information system 10 according to an embodiment of the present invention. The upper table is an example of research that performed a retail establishment search independently by the search performing user, and the lower table is an example of the results of performing a retail establishment search by the search performing user along with other users 1 through 5.

In the upper table, the information detecting part 226 customized the information of four retail establishments that matched search conditions for retail establishments within a predetermined distance from a specific location (for example a train station), and arranged in order of highest estimated value for the degree of satisfaction of the search performing user. The estimate of the degree of satisfaction was calculated based at least on the prerecorded attribute information of the user. For example, the estimate of the degree of satisfaction for a retail establishment can be calculated by applying attribute information such as the food preference, body characteristics, and health condition to the information of the retail establishment, scoring the retail establishment for each attribute information, and totaling the scored values or the like. The estimate of the degree of satisfaction can also be calculated based on the evaluation of a website or the like that handles information for eating establishments or based on evaluation prerecorded for the retail establishment.

For example, the evaluation by a word-of-mouth website for four retail establishments are all 50 points, and “preference for soba noodles 1.6 (preferable)”, “preference for Italian restaurants 1.2 (slightly preferable)”, “preference for family restaurants 1.0 (no opinion)” and “preference for fast food 0.8 (slightly unfavorable)” is included in the attribute information of the search performing user. In this case, the information searching part 226 of the server 200 can determine the estimate of the degree of satisfaction for each retail establishment by the search performing user by multiplying the evaluation for each retail establishment by the word-of-mouth website or the like by the preference for the genre of each retail establishment by the search performing user. The results of the information searching part 226 customizing and searching based only on the attribute information of the search performing user are as illustrated in the upper table, where soba noodle shop X has the highest rank, and fast food M has the lowest rank.

The lower table is an example where the information searching part 226 specifies the information of four retail establishments that match the search conditions, customizes the information for the retail establishments, and arranges the information in order of highest estimated value for the overall degree of satisfaction of the search performing user and the other users 1 through 5. The information searching part 226 can customize the information including all of the degrees of satisfaction of the users rather than just the total degree of satisfaction of all users. The estimated value for the degree of satisfaction of the other users 1 through 5 is calculated by the same method as in the upper table. The overall degree of satisfaction is calculated from the average estimated value for the degree of satisfaction of the search performing user and each of the other users 1 through 5.

The information searching part 226 can customize the search information so that the search results of retail establishments of a genre that has a possibility of having food allergies by some of the users can be ranked lowest or eliminated from the test results. In the example of the lower table, the user 1 has attribute information of a “soba noodle allergy”. Therefore, the results of the retail establishment search by the information searching part 226 based on the attribute information of the search performing user and users 1 through 5 will give the lowest ranking to the soba noodle shop X even though the estimated value for the degree of satisfaction by all users was average.

Hearing, the information searching part 226 can arrange the information in order of the highest degree of satisfaction for user where the degree of satisfaction is lowest, instead of arranging the searched information in order of the total degree of satisfaction of all users. Therefore, a portion of the users will not have pronounced dissatisfaction with the search results. Furthermore, alternatively, the information detecting part 226 can arrange the information in order of the highest number of users where the degree of satisfaction was the highest. Thereby, at least a portion of the users can be extremely satisfied by the search results.

Furthermore, the information detecting part 226 can customize the information to strongly reflect the intentions of a priority user by increasing the weight of the attribute information of the priority user. For example, the information searching part 226 can correct the average estimated value of the degree of satisfaction of each of the users 1 through 5 so that the estimated value for the degree of satisfaction of a priority user will be weighted higher when calculating the overall degree of satisfaction. Thereby, the information searching part 226 can provide search results that provide a high level of satisfaction to a priority user that the search performing user intends to give priority for respecting the intentions of each of the users.

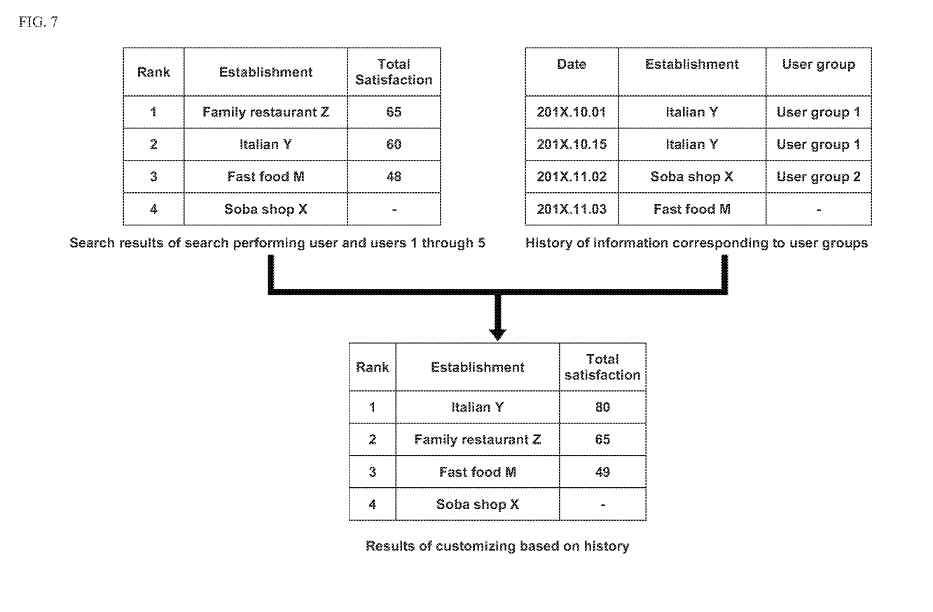

FIG. 7 illustrates an example of a retail establishment search that considers history using an information system 10 according to an embodiment of the present invention.

The left upper table shows the results for the same retail establishment search as the lower table in FIG. 6 by the search performing user and the other users 1 through 5. The right upper table is an example of the history of retail establishments that were selected and searches in the past by the search performing user using the information system 10. The lower table shows the retail establishment search results of the left upper table that had been further customized based on the history of the right upper table.

The displaying part 112 of the information terminal customizes such that the search results will be higher for a retail establishment that was recorded to correspond to a user group that was the same or similar to the user group containing the other users 1 through 5 that were detected in the present retail establishment search. For example, displaying part 112 multiplies the number of visits by a user group 1 that includes the other users 1 through 5 by 10 points and adds to the overall degree of satisfaction for the retail establishments acquired from the server 200, and then multiplies the number of single visits by the search performing user by 1 point and then adds together.

According to the right upper table, the search performing user has visited Italian restaurant Y two times in the past with user group 1, and visited fast food M alone. As a result, the overall degree of satisfaction for the Italian restaurant is calculated by adding the number of visits 2 times×10 points to 60 points to make 80 point. Furthermore, the degree of satisfaction for fast food M is calculated by adding the number of visits 1 time×1 point to 48 points to make 49 points. In this manner, results that consider the past history are arranged so that the Italian restaurant Y is higher than the family restaurant Z.

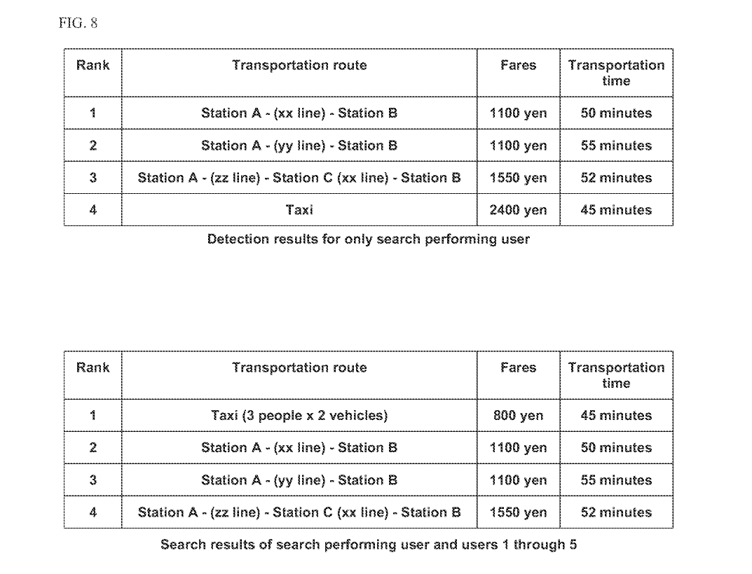

FIG. 8 illustrates an example of a transfer path search using an information system 10 according to an embodiment of the present invention. The upper table illustrates a case where the displaying part 112 displays the results where only the transportation route search of the search performing user was performed, without the presence of other users, and the lower table illustrates the case where the displaying part 112 displays the results of performing the transportation route search for both the search performing user and the other users 1 through 5.

In the upper table, the information for the transportation route of four cases that match the search results for transporting from a specific departure location to an arrival location are displayed in order of inexpensive fares, and if the transport route fares are the same, the transport route are displayed in order of the shortest transportation time. In the upper table, the fares for the roots displayed in position 1 and position 2 are the same, but the transportation route that uses line xx has a shorter transportation time, and therefore is displayed in a higher position. Furthermore, the transportation route that uses a taxi has the shortest transportation time, but the fares are highest, and therefore are displayed at the lowest position.

In the lower table, the displaying part 112 of the information terminal 100 displays the information for the transportation routes of the four cases that match the search conditions in order of the cheapest fares for the case of transporting the search performing user and the other users 1 through 5. If a plurality of people travel together by taxi, the fares per person will be less expensive because the fares are covered by all of the passengers.

For example, if six people including the search performing user and users 1 through 5 share a taxi, the fair per person will be 2400 yen×2 vehicles/6 people=800 yen. As a result, transportation by taxi is the transportation route with the least expensive fares, so the search results are customized so that transportation route by taxi is displayed in the highest position.

Furthermore, for example, if one or more of the users 1 through 5 of the other information terminals 300a or the like has a physical handicap, the server 200 will display transportation routes that are barrier free in the top position. In this manner, the server 200 can customize the information that was detected based on the number of information terminals acquired by the information terminal 100 and other user attribute information.

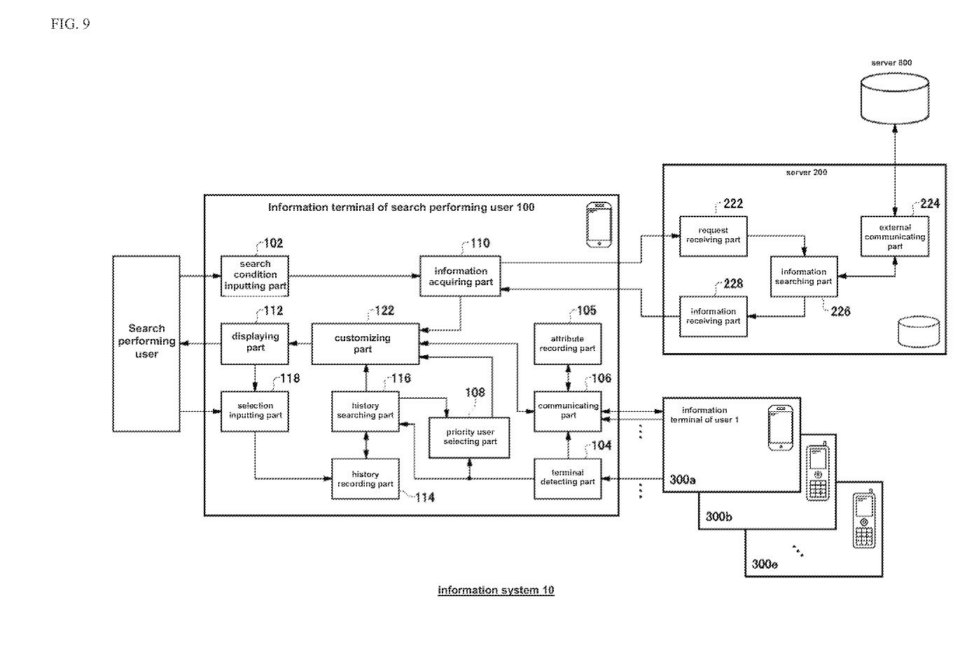

FIG. 9 illustrates a specific structure of an information system 10 according to a first alternate example of an embodiment of the present invention. In the alternate example, the information terminal 100 of the search performing user acquires information that matches the search conditions from the server 200, and customizes and displays the information acquired on the information terminal 100 side based on the attribute information of the search performing user and the other users 1 through 5. In the description of the alternate example, elements which have essentially the same function and configuration as in the embodiments of the present invention are assigned the same codes, and a description has been omitted.

In the alternate example, the information terminal 100 of the search performing user also contains a customizing part 122. The information acquiring part 110 transmits the search conditions to the server based on the search request, and acquires from the server 200 information that matches the search conditions. The information acquiring part 110 transmits the acquired information to the customizing part 122.

The customizing part 122 acquires information that matches the search conditions from the information acquiring part 110. The customizing part 122 acquires from the communicating part 106 the communication results with the other information terminals 300a through 300e that includes the attribute information of the search performing user and the other users. The customizing part 122 can also acquire information related to the priority user from the priority user selecting part 108.

The customizing part 122 customizes the information acquired from the information acquiring part 110 based on the communication results with the other information terminals 300a through 300e. The customizing part 122 can customize the acquired information using the same method as the information detecting part 226 that was described using FIG. 2 through FIG. 8 in the embodiment of the present invention.

The customizing part 122 can acquire history of the information that has been selected in the past by the search performing user or a user group from the history searching part 116, and further customizes the information based on the acquired history. The customizing part 122 provides the customized information to the displaying part 112.

The displaying part 112 displays the customized information provided from the customizing part 122. If the customizing part 122 customizes based on the history, the displaying part 112 does not need to perform customizing based on the history. Alternatively, it is also acceptable for the customizing part 122 to not customize based on the history, and for the displaying part 112 to perform customizing based on the history.

The request receiving part 222 of the server 200 receives a search request that includes search conditions from the information acquiring part 110 of the information terminal 100, and provides the search request to the information searching part 226. In the alternate example, the attribute information of the search performing user and the users 1 through 5 of the other information terminals 300a and the like are not included in the search request. The information searching part 226 searches for information that matches the search conditions acquired from the information terminal 100, and provides the information to the information transmitting part 228. The information transmitting part 228 transmits the information that was found to the information acquiring part 110 of the information terminal 100.

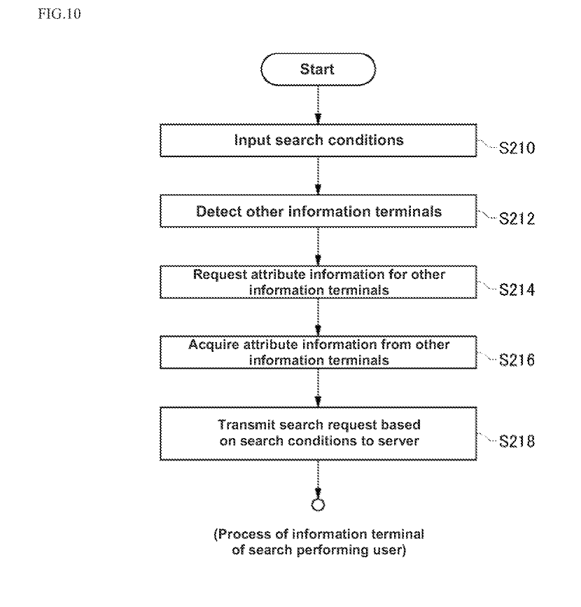

FIG. 10 through FIG. 12 illustrates the process flow of an information system 10 according to a first alternate example of the embodiment of the present invention. In the alternate example, the information terminal 100 transmits search conditions to the server 200, the server 200 returns to the information terminal 100 information that matches the search conditions, and the information terminal 100 customizes the information acquired from the server 200 based on the communication results with the other information terminals 300a and the like. The information system 10 performs a customized search by the processes of S210 through S240.

FIG. 10 illustrates the process flow of a first alternate example of the embodiment of the present invention performed by the information terminal 100 of the search performing user. The process from S210 to S214 corresponds to the process from S110 to S114 in FIG. 3.

In step S216, the communicating part 106 acquires attribute information of the other users from the other information terminals 300a through 300e. Furthermore, the communicating part 106 retrieves the attribute information of the search performing user from the attribute recording part 105. The communicating part 106 provides the attribute information of the search performing user and other users that was acquired and/or the communication results including the number of other information terminals to the customizing part 122.

In S218, the information acquiring part 110 transmits a search request including communication results based on search conditions acquired by the search condition inputting part 102 to the server 200.

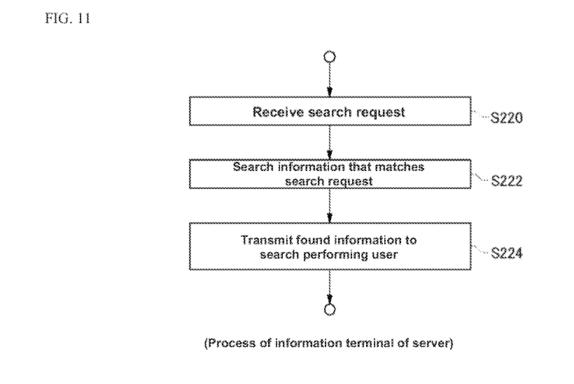

FIG. 11 illustrates the process flow for a first alternate example of the embodiment of the present invention that is performed by the server 200 after S218. In S220, the request receiving part 222 of the server 200 receives a search request from the information acquiring part 110 of the information terminal 100. The request receiving part 222 provides the search request that was received to the information searching part 226.

Next, in S222, the information searching part 226 communicates with an external server 800 via an external device communicating part 224, and searches for information that matches with the search conditions specified in the search request. The information detecting part 226 transmits the information that was found to the information transmitting part 228.

Next, in S224, the information transmitting part 228 acquires the information that was found from the information searching part 226, and transmits the acquired information through a network to the communicating part of the information terminal 100 of the search performing user.

Note, in the alternate example, the information terminal 100 performs S218 after S210, and performs S216 after S212. Thereby, the information terminal 100 can perform the processes of S212 through S216 in parallel with the server 200 performing S220 through S224, and thereby the search time can be shortened.

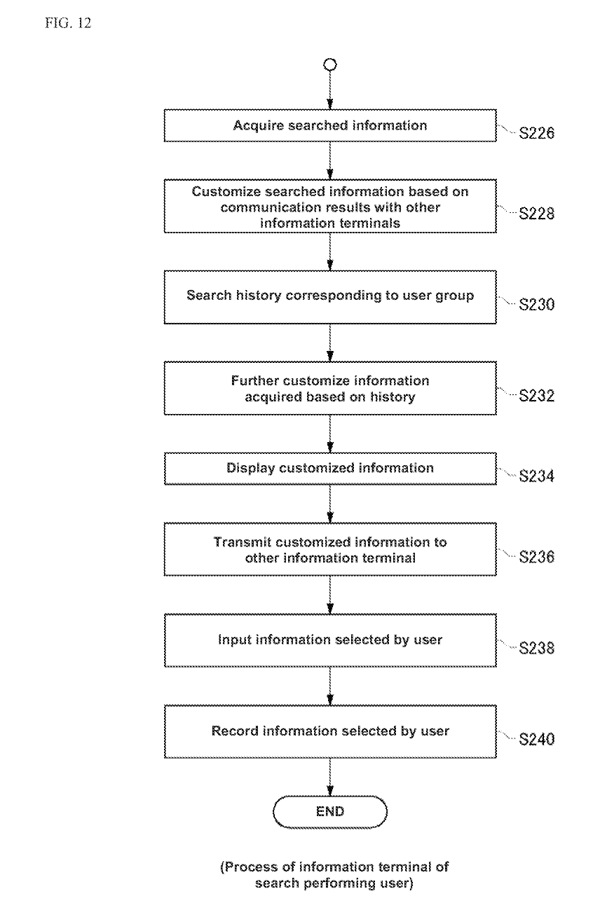

FIG. 12 illustrates the process flow of the first alternate example of the embodiment of the present invention performed after S224 by the information terminal 100 of the search performing user. In S226, the information acquiring part 110 of the information terminal 100 acquires information that was searched by the information transmitting part 228 of the server 200. The information acquiring part 110 provides the acquired information to the customizing part 122.

Next, in S228, the customizing part 122 customizes the information acquired from the information acquiring part 110 based on the communication results with the other information terminals 300a through 300e. The customizing part can customize the acquired information based on the attribute information and the like of the search performing user and other users, using the same method as in S122 by the information searching part 226 as described in FIG. 4.

Next, in S230, the history searching part 116 searches the history of information that corresponds to the user group from the history recording part 114. Process S230 can be the same process as S128 described in FIG. 12.

Next, in S232, the customizing part 122 further customizes the plurality of information received from the information acquiring part 110, based on the historical information received from the history searching part 116.

The details of customizing in S232 can be the same as in S130 described in FIG. 12.

Next, the information system 10 moves the process to S234. The process from S234 to S240 corresponds to the process from S132 to S138 in FIG. 5.

This manner, with this alternate example, the information terminal 100 of the search performing user acquires the information that matches the search conditions from the server 200, and customizes the information that was acquired in the information terminal 100 based on the attribute information and the like of the user. Therefore, the amount of communication between the information terminal 100 and server 200 is reduced, and thus information terminal 100 can more quickly display the customized information particularly when the communication environment is unfavorable.

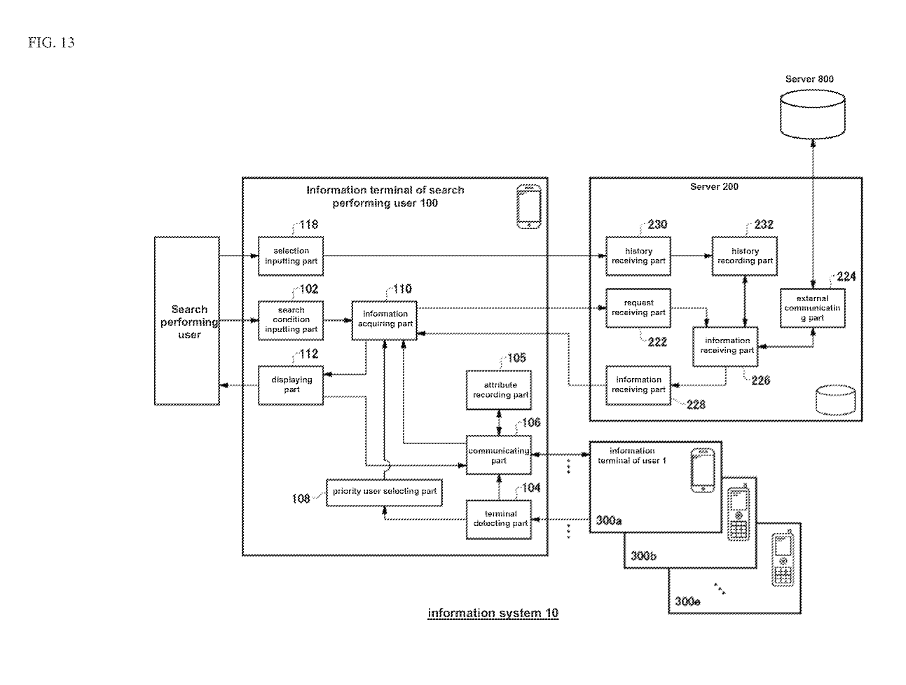

FIG. 13 illustrates a specific structure of an information system 10 according to a second alternate example of an embodiment of the present invention. In this alternate example, the server 200 matches the search conditions, and searches the customized information based on attribute information and information history. In the description of the alternate example, elements which have essentially the same function and configuration as in the embodiments of the present invention are assigned the same codes, and a description has been omitted.

The information terminal 100 of the alternate example contains a search condition input part 102, terminal detecting part 104, attribute recording part 105, communicating part 106, priority user selecting part 108, information acquiring part 110, display part 112, and selection inputting part 118. In the alternate example, the selection inputting part 118 inputs the information selected by the search performing user from a plurality of information that are provided by the displaying part 112, and provide the selected information to the history of receiving part 230 of the server 200.

The server 200 includes a request receiving part 222, external device communicating part 224, information searching part 226, information transmitting part 228, history receiving part 230, and history recording part 232. The history receiving part 230 receives from the selection inputting part 118 of the information terminal 100 the history of information selected by the search performing user from among a plurality of information that was searched, and provides the information to the history recording part 232. The history recording part 232 records the history that was received.

The information searching part 226 matches the search conditions that were specified in the search request based on the search request, and the attribute information of the search performing user and the other users and/or communication results that includes the number of users, and searches the customized information based on these communication results. Furthermore, the information searching part 226 can search for further customized information based on the history of the information that was recorded in the history recording part 232. The information detecting part 226 provides the customized information to the information transmitting part 228.

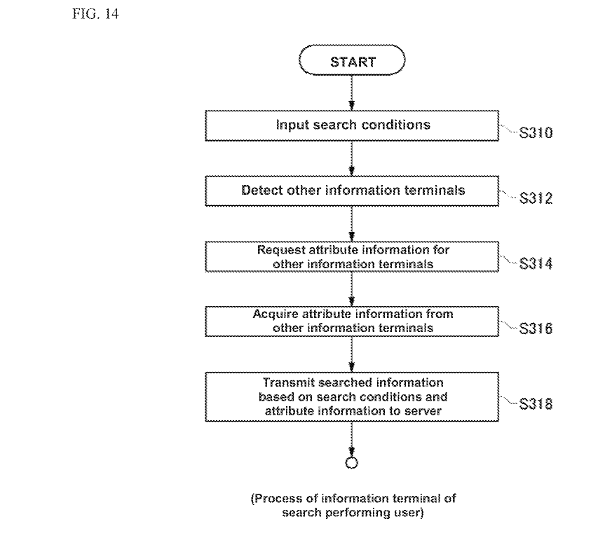

FIG. 14 through FIG. 16 illustrates the process flow of an information system 10 according to a second alternate example of the embodiment of the present invention. In the alternate example, the information terminal 100 transmit the search conditions and the communication results with other information terminals 300a and the like to the server 200, and then the server 200 matches the search conditions, and returns to the information terminal 100 the customized information based on the communication results and the history, and the information terminal 100 displays the information acquired from the server. The information system 10 performs a customized search by the processes of S310 through S342.

FIG. 14 illustrates the process flow of the second alternate example of the embodiment of the present invention performed by the information terminal 100 of the search performing user. The process from S310 to S318 corresponds to the process from S110 to S118 in FIG. 3.

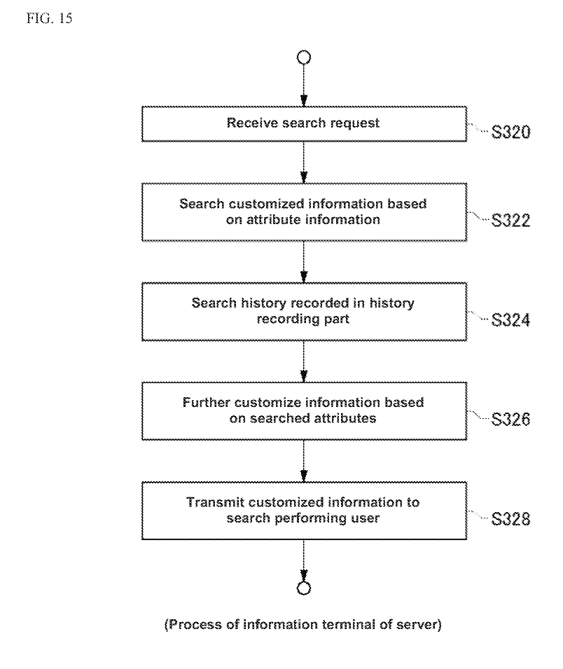

FIG. 15 illustrates the process flow for the second alternate example of the embodiment of the present invention that is performed by the server 200 after S318. The processes of S320 and S322 correspond to the processes of S120 and S114 in FIG. 4. The information system 10 proceeds to S324 after S322.

In S324, the information searching part 226 can search the history of the information that was recorded in the history recording part 232. Searching of the history in the history recording part 232 by the information searching part 226 is the same as searching for the history in the history recording part 114 by the history searching part 116 in S128 described in FIG. 12.

Next, in S326, the information searching part 226 further customizes the information that was customized based on the communication results in S322, based on the history of the information that was searched. Customizing using the history of the information searching part 226 can be the same as customizing the display part 112 in S130 described in FIG. 12. The information detecting part 226 transmits the customized information to the information transmitting part 228.

Next, in S328, the information transmitting part 228 transmits the customized information that was acquired to the communicating part 106 of the information terminal 100.

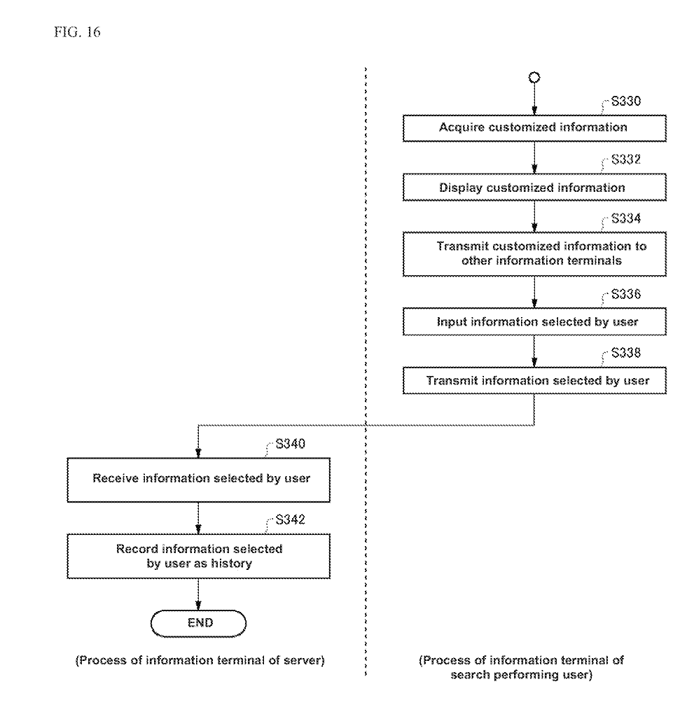

FIG. 16 illustrates the process flow of the second alternate example of the embodiment of the present invention performed after S328 by the server 200 and the information terminal 100. In S330, the information acquiring part 110 of the information terminal 100 acquires information that has been searched and customized by the server based on the attribute information and history. The process from S332 to S336 corresponds to the process from S132 to S136 in FIG. 5.

Next, in S338, the selection inputting part 118 transmits the information selected by the search performing user to the history receiving part 230 of the server 200. Next, in S340, the history receiving part 230 of the server 200 receives the information selected by the search performing user. Next, in S342, the history receiving part 230 records the information selected by the search performing user in the history recording part 232.

In this manner, the information system of this alternate example matches the search conditions in the server 200 using the processes according to S310 through S342, and can search the customized information based on the history of the information that was selected in the past and the attribute information of the plurality of users. Thereby, the information system 10 can provide optimized search results to a plurality of users that are jointly performing a search, without installing an application that customizes the searched information in a separate information terminal 100.

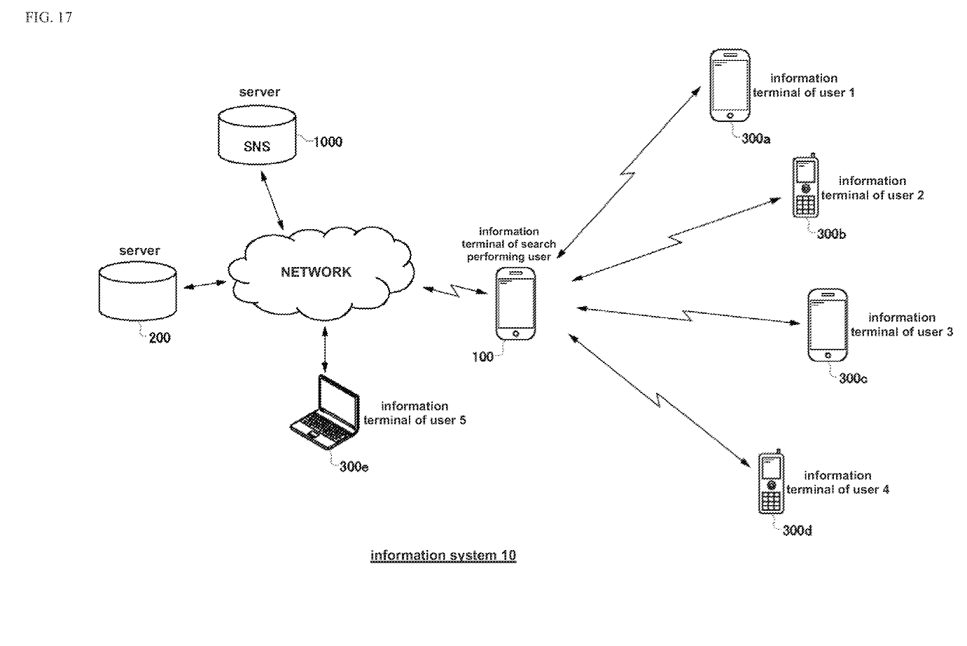

FIG. 17 illustrates an outline of an information system 10 according to a third alternate example of an embodiment of the present invention. With this alternate example, the information terminal 300e of user 5 is located far away from the information terminal 100, and communicates with information terminal 100 via a network. Furthermore, the information terminal 100, server 200, and other user information terminals 300a through 300e communicate with a server 1000 that provides SNS via a network. In the description of the alternate example, elements which have essentially the same function and configuration as in the embodiments of the present invention are assigned the same codes, and a description has been omitted.

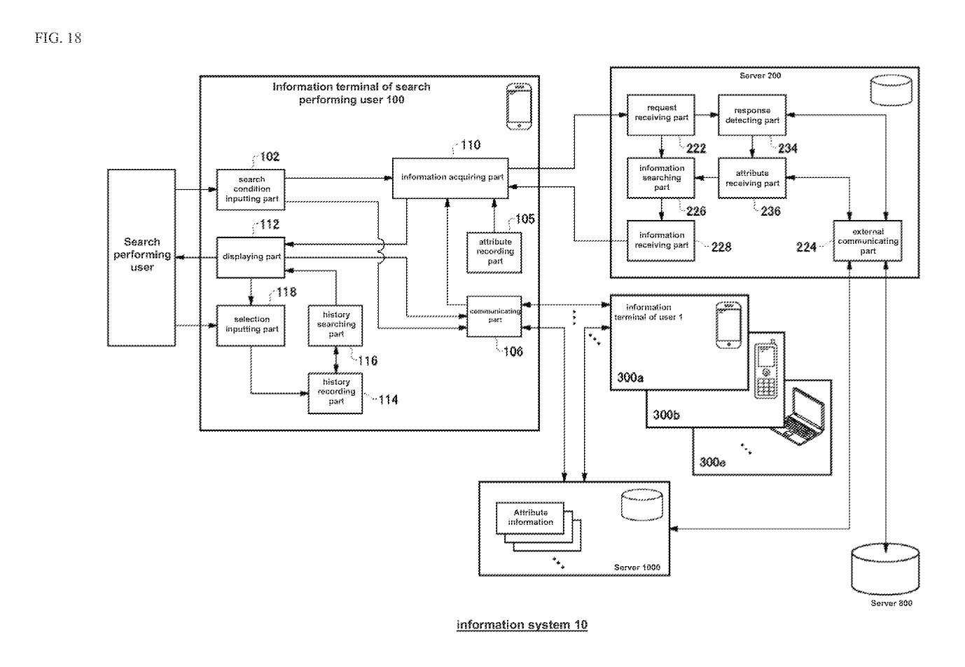

FIG. 18 illustrates a specific structure of an information system 10 according to this alternate example. With this alternate example, the server 200 acquires the number of other information terminals 300a and the like as well as the attribute information of the other users 1 through 5 and communicates with the server 1000 that provides SNS, instead of acquiring the attribute information of the other users 1 through 5 via the information terminal 100. In this alternate example, the information terminal 100 contains a search condition input part 102, terminal detecting part 104, attribute recording part 105, communicating part 106, information acquiring part 110, display part 112, history recording part 114, history searching part 116, and selection inputting part 118.

The search condition inputting part 102 provides the input search conditions to the communicating part 106 and the information acquiring part 110. The communicating part 106 submits contents related to the search conditions to the server 1000.

The communicating part 106 transmits introducing information via near distance communication or via a network to the other information terminals 300a through 300e. The introducing information can include the URL of content submitted by the communicating part 106. The communicating part 106 provides information such as the URL related to submitted contents to the information acquiring part 110.

The users 1 through 5 of the other information terminals 300a through 300e that received inviting information will for example access the contents that were submitted by the information terminal 100 of the search performing user, and will participate in displaying to the search performing user by pressing a button that says “Great!” in the contents. The communicating part 106 may receive inviting information from the other information terminals 300a through 300e if the other information terminals 300a through 300e perform a search.

The information acquiring part 110 transmits search request that includes the search conditions and information related to contents that are submitted to the server 200 via a network such as the Internet or the like. The information acquiring part 110 also receives the attribute information of the search performing user from the attribute recording part 105, and can transmit the information together with the search request to the server 200.

With this alternate example, the server 200 detects users 1 through 5 of the other information terminals 300a through 300e, and acquires the number of other information terminals 300a and the like as well as the attribute information of the other users 1 through 5. The server 200 searches the information that was customized based on the attribute information that was acquired and the search conditions, and transmits the results to the information terminal 100. The server 200 includes a request receiving part 222, external device communicating part 224, information searching part 226, information transmitting part 228, response detecting part 234, and an attribute receiving part 236.

The request receiving part 222 receives the search request and the information related to be submitted contents from the information acquiring part 110 of the information terminal 100 of the search performing user. The request receiving part 222 provides the search request to the information searching part 226. The request receiving part 222 acquires the attribute information of the search performing user from the information acquiring part 110, and provides the information to the information searching part 226. Furthermore, the request receiving part 222 provides the information related to the submitted contents to the response detecting part 234.

The response detecting part 234 detects the search performing user and the other users. For example, the response detecting part 234 communicates with the server 1000 via and external communicating part 224, and specifies other users 1 through 5 that have pressed the “Great!” button. The response detecting part 234 acquires information concerning the number of other information terminals 300a and the like as well as account information for the other users 1 through 5, and transmits the information to the attribute receiving part 236.

The attribute receiving part 236 acquires attribute information for the other users 1 through 5 from the information that was acquired from the response detecting part 234. The attribute receiving part 236 communicates with the server 1000 via the external communicating part 224, and acquires information such as the profile of each user and participating communities and the like from the account information and the like of the specified users 1 through 5. The attribute receiving part 236 may also acquire information such as the profile of the search performing user. The attribute receiving part 236 acquires attribute information for the other users 1 through 5 corresponding to the search performing user from the information such as the profile that was acquired from the response detecting part 234. The attribute receiving part 236 may also acquire attribute information of the search performing user from the profile of the search performing user. The action through receiving part 236 transmits the attribute information that was acquired and the number of other information terminals 300a and the like to the information searching part 226.

The information searching part 226 acquires the attribute information of the other users 1 through 5 and the number of other information terminals 300a and the like from the attribute receiving part 236. Furthermore, the information searching part 226 may also acquire the attribute information of the search performing user from the request receiving part 222 or the attribute receiving part 236. The information searching part 226 matches the search conditions specified in the search request based on the search request, the attribute information of the acquired users, and the number of other information terminals 300a, and searches the information that has been customized based on the attribute information of the search performing user and other users.

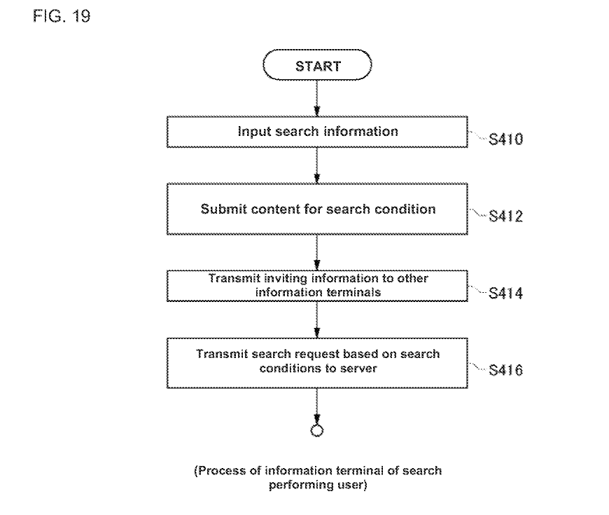

FIG. 19 through FIG. 31 illustrates the process flow of an information system 10 according to a third alternate example of the embodiment of the present invention. In this alternate example, the information terminal 100 submits contents to the server 1000 that provides SNS, and transmits the search conditions to the server 200. The server 200 acquires the attribute information of the other users from the server 1000 that provides SNS, matches the search conditions, and returns the customized information to the information terminal 100 based on the attribute information. The information terminal 100 further customizes the information from the server 200, based on history. The information system 10 performs a customized search by the processes of S410 through S440.

FIG. 19 illustrates the process flow for the third alternate example of the embodiment of the present invention that is performed by the information terminal 100. First, in S410, the search condition inputting part 102 of the information terminal 100 inputs the search conditions from the search performing user. The search condition inputting part 102 provides the input search conditions to the communicating part 106 and the information acquiring part 110.

Next, in S412, the communicating part 106 submits contents related to the search conditions that were acquired to the server 1000. The submitted contents can be for example guiding instructions to a social gathering held at a specific date and location.

Next, in S414, the communicating part 106 transmits introducing information including the URL of content submitted by the communicating part 106 via near distance communication or via a network to the other information terminals 300a through 300e. The communicating part 106 provides information such as the URL for the submitted contents to the information acquiring part 110.

Next, in S416, the information acquiring part 110 transmits a search request including content information that was acquired from the communicating part 106 and search conditions acquired from the search condition inputting part 102 to the server 200. The information acquiring part 110 also acquires the attribute information of the search performing user from the attribute recording part 105, and transmits the information to the server 200.

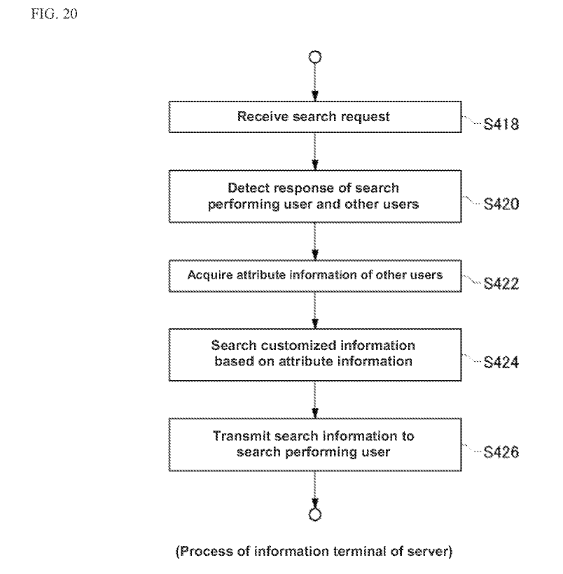

FIG. 20 illustrates the process flow for the third alternate example of the embodiment of the present invention that is performed by the server 200 after S416. In S418, the request receiving part 222 of the server 200 receives a search request and information related to the content information from the information acquiring part 110 of the information terminal 100. The request receiving part 222 provides the search request that was received to the information searching part 226, and provides the content information to the response detecting part 234. When the request receiving part 222 receives the attribute information of the search performing user, the request receiving part 222 can provide the attribute information to the information searching part 226.

Next, in S420, the response detecting part 234 communicates with the server 1000 via and external communicating part 224, and detects correspondence between the search performing user and the other users by determining the users 1 through 5 that have pressed the “Great!” button. The response detecting part 234 transmits information concerning the number of other information terminals 300a and the like as well as account information for the users 1 through 5 that was acquired to the attribute receiving part 236.

Next, in S422, the attribute receiving part 236 accesses the server 1000 via the external communicating part 224, and acquires information such as the profile of each user and participating communities and the like from the accounts and the like of the specified users 1 through 5. The attribute receiving part 236 analyzes the information related to the user that is included in profile that was acquired from the response detecting part 234, and acquires the attribute information for the other users 1 through 5 corresponding to the search performing user. The attribute receiving part 236 may also acquire attribute information of the search performing user from the profile of the search performing user. The action through receiving part 236 transmits the attribute information that was acquired and the number of other information terminals 300a and the like to the information searching part 226.

Next, in S424, the information searching part 226 acquires the search conditions from the request receiving part 222, and acquires the attribute information of the other users 1 through 5 and the number of other information terminals 300a and the like from the attribute receiving part 236. Furthermore, the information searching part 226 receives the attribute information of the search performing user from at least one of the request receiving part 222 or the attribute receiving part 236. The information searching part 226 can customize the information that was searched using the same method as described in S1 to 2 of FIG. 4 based on the search request that was acquired, the attribute information, and the number of other information terminals 300a and the like.

Next, in S426, the information transmitting part 228 acquires the customized information from the information searching part 226, and transmits the acquired information through a network to the communicating part of the information terminal 100 of the search performing user.

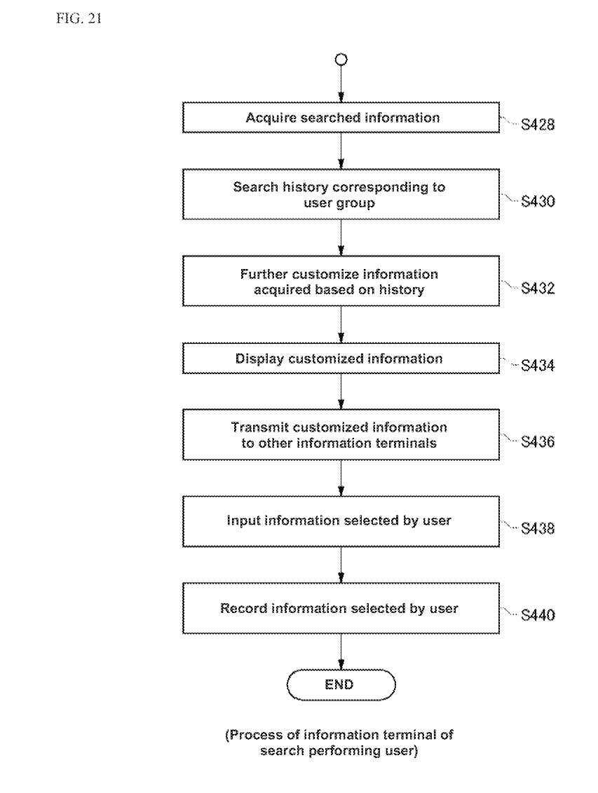

FIG. 21 expresses the process flow for the third alternate example of the embodiment of the present invention that is performed by the information terminal 100 after S426. The process from S428 to S440 illustrated in FIG. 21 corresponds to the process from S126 to S138 in FIG. 5.

In this manner, the information system of this alternate example acquires the attribute information of users that will participate in an event using SNS, by the processes of S410 through S438, and can provide the optimized search results to the users that will be participating in the event.

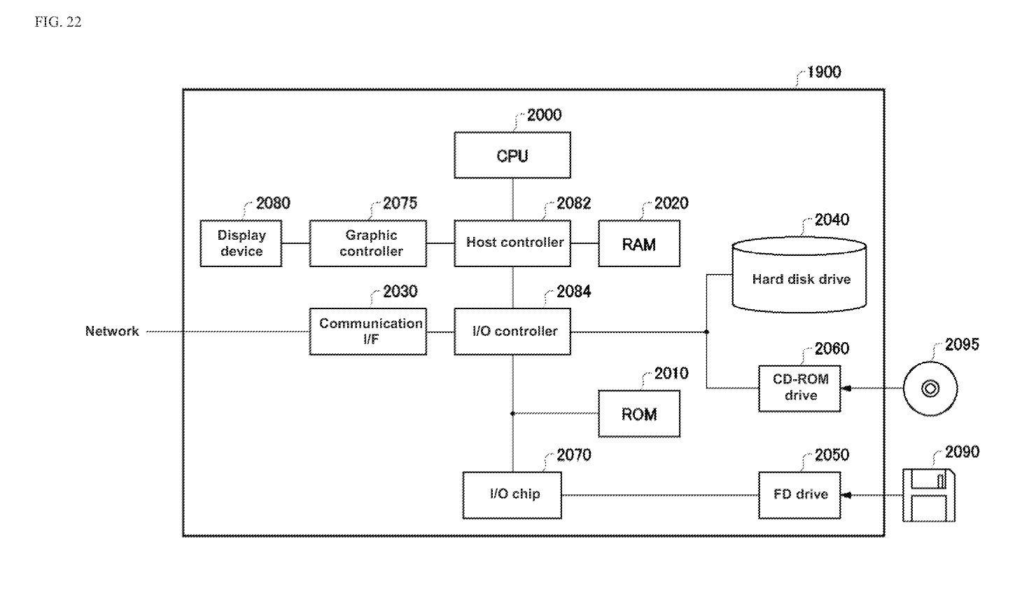

FIG. 22 illustrates an example of a hardware configuration of a computer 1900 that functions as the information terminal 100, server 200, and other information terminals 300a through 300e. The computer 1900 according to an embodiment of the present invention has a CPU periphery part with a CPU 2000, RAM 2020, graphic controller 2075, and display device 2080, connected by a host controller 2082, an input output part with a communication interface 2030, hard disk drive 2040, and CD-ROM drive 2060, connected to the host controller 2082 by an input output controller 2084, and a legacy input output part with ROM 2010, flexible disk drive 2050, and input output chip 2070 connected to the input output controller 2084.

The host controller 2082 connects the RAM 2020, the CPU 2000 that accesses the RAM 2020 at a high transfer rate, and the graphic controller 2075. The CPU 2000 operates and controls the various parts based on a program that is stored in the ROM 2010 and the RAM 2020. The graphic controller 2075 acquires image data generated in a frame buffer provided in the RAM 2020 and displays the image on the display device 2080. Alternatively, the graphic controller 2075 may internally include a frame buffer that stores image data to be reproduced by the CPU 2000 or the like.

The input output controller 2084 connects the host controller 2082, the communication interface 2030 which is a relatively high-speed input output device, the hard disk drive 2040, and the CD-ROM drive 2060. The communication interface 2030 communicates with other devices through a network, either wirelessly or by wire. The communication interface functions as hardware that performs communication containing a communicating part 106, a terminal detecting part 104, and information acquiring part 110, and an external communicating part 224. The hard disk drive 2040 stores data and programs to be used by the CPU 2000 in the computer 1900. The CD-ROM drive 2060 reads data or programs from a CD-ROM 2095 and provides the data or program to the hard disk drive 2040 via the RAM 2020.

Furthermore, the input output controller 2084 is connected to the ROM 2010, flexible disk drive 2050, and an input output device with a relatively low-speed input output chip 2070. The ROM 2010 stores a boot program that is executed when starting the computer 1900, and/or programs or the like that depend on the hardware of the computer 1900. The flexible disk drive 2050 reads the program or data from a flexible disk 2090, and provides the program or data to the hard disk drive 2040 via the RAM 2020. The input output chip 2070 connects the flexible disk drive 2050 to the input output controller 2084, and also connects various types of input output devices to the input output controller 2084 via a parallel port, serial port, keyboard port, mouse port, or the like.

The program provided to the hard disk drive 2040 via the ramp 2020 is provided by a user and stored on a recording medium such as a flexible disk 2090, CD-ROM 2095, or IC card or the like. The program is read from the recording medium, installed into the hard disk drive 2040 in the computer 1900 via the ramp 2020, and executed in the CPU 2000.

The program that is installed on the computer 1900 thereby causing the computer to function as the information terminal 100 or as another information terminal 300a through 300e has a search condition inputting module, a terminal detecting module, an attribute recording module, a communicating module, a priority user selecting module, an information acquiring module, a display module, a history recording module, a history searching module, a selection inputting module, and a customizing module. These programs and modules can also act on the CPU 2000 or the like and cause the computer 1900 to function as a search condition inputting part 102, a terminal detecting part 104, an attribute recording part 105, a communicating part 106, a priority user selecting part 108, an information acquiring part 110, a display part 112, a history recording part 114, a history searching part 116, a selection inputting part 118, and a customizing part 122 which are specific means that operate in conjunction with software and the aforementioned various types of hardware resources.

The program that is installed on a computer 1900 thereby causing the computer to function as the server 200 or has a request receiving module, an external device communicating module, an information searching module, an information transmitting module, a history receiving module, a history recording module, a response detecting module, and an attribute receiving module. These programs and modules can also act on the CPU 2000 or the like and cause the computer 1900 to function as a request receiving part 222, an external device communicating part 224, an information detecting part 226, an information transmitting part 228, a history receiving part 230, a history recording part 232, a response detecting part 234, and an attribute receiving part 236, which are specific means that operate in conjunction with software and the aforementioned various types of hardware resources.

The information processing specified by these programs are read by the computer 1900, and function as a search condition inputting part 102, a terminal detecting part 104, an attribute recording part 105, a communicating part 106, a priority user selecting part 108, an information acquiring part 110, a display part 112, a history recording part 114, a history searching part 116, a selection inputting part 118, a customizing part 122, request receiving part 222, an external device communicating part 224, an information detecting part 226, an information transmitting part 228, a history receiving part 230, a history recording part 232, a response detecting part 234, and an attribute receiving part 236, which are specific means that operating conjunction with software and the aforementioned various types of hardware resources. Furthermore, a unique information terminal 100, server 200, and other information terminals 300a through 300e are formed by calculating and/or processing information based on the objective of use of the computer 1900 in the embodiment of the present invention, using the specific means.

As an example, when communication is performed between the computer 1900 and an external device or the like, the CPU 2000 executes a communication program loaded onto the RAM 2020, and communication processing instructions are provided to the communication interface 2030 based on the processing details recorded in the communication program. The communication interface 2030 is controlled by the CPU 2000, reads transmission data stored in the transfer buffer region or the like provided on a storage device such as the RAM 2020, hard disk drive 2040, flexible disk 2090, or CD-ROM 2095 and transmits to a network, or writes the reception data received from the network to a reception buffer region or the like provided on the storage device. In this manner, the communication interface 2030 can transfer transmission data to a memory device using a DNA (direct memory access) method, or alternatively, the CPU 2000 reads data from the communication interface or the memory device transmission source and then forwards the transmission data by writing the data to the storage device or to the communication interface 2030 of the forwarding destination.

Furthermore, the CPU 2000 reads all or the necessary parts of the file or database or the like stored in an external storage device such as a hard disk drive 2040, CD drive 2060 (CD-ROM 2095), flexible disk drive 2050 (flexible disk 2090) and the like, on to the RAM 2020 using DMA forwarding or the like, and performs various types of processes on the data on the RAM 2020. Furthermore, the CPU 2000 returns the processed data to the external storage device using DMA forwarding or the like. During this type of processing, the RAM 2020 temporarily holds the content of an external storage device, and therefore with the embodiment of the present invention, the RAM 2020 and the external storage device and the like are generally referred to as memory, memory part, or memory device or the like. The various types of information such as the various programs, data, tables, databases, and the like in the embodiments of the present invention are stored in this type of memory device, and are subject to information processing. Note, the CPU 2000 maintains a portion of the RAM 2020 as cache memory, and can perform reading and writing onto the cache memory. Under this condition, the cache memory performs a part of the function of the RAM 2020, so in the embodiments of the present invention, unless otherwise expressly distinguished, the cache memory includes the RAM 2020, memory, and/or memory devices.

Furthermore, the CPU 2000 performs various types of processes including the various types of calculations, information processing, condition determination, information searching and replacing, and the like that are included in the embodiment the present invention and specified by a command sequence of a program with regards to the data that was read, and the CPU 2000 also writes back to RAM 2020. For example, when determining conditions, the CPU 2000 compares various types of variables described in the embodiments to other variables or constants, and determines whether conditions such as larger, smaller, no less than, no more than, or equal to, or the like are satisfied, and if the conditions are satisfied or if not satisfied, the CPU 2000 branches to a different command string or calls out a subroutine.

Furthermore, this CPU 2000 and can search for information that is stored in a file or database or the like in the memory device. For example, for the case a plurality of entries associated with an attribute value of a second attribute with regards to the attribute value of a first attribute are stored in a memory device, the CPU 2000 searches for an entry that matches the conditions specified by the attribute value of the first attribute from the plurality of entries stored in the memory device, and reads the attribute value of the second attribute that is stored in the entry, and thereby the attribute value of the second attribute that is associated with the first attribute that satisfies predetermined conditions can be obtained.

The aforementioned programs or modules can also be stored on an external recording medium. The recording medium can be a flexible disk 2090, CD-ROM 2095, as well as an optical recording medium such as a CD or the like, and optical magnetic recording medium such as MO, tape medium, semiconductor memory such as an IC card, or the like. Furthermore, a memory device such as a hard disk or RAM provided on a server system that is connected to a dedicated communication network or the Internet can be used as the recording medium, and the program can be provided to the computer 1900 through the network.

The present invention was described above using an embodiment, but the technical scope of the present invention is not restricted to the scope disclosed in the aforementioned embodiments. It is obvious to one skilled in the art that various modifications and improvements to the aforementioned embodiment are possible. Embodiments with these changes or improvements are included in the technical scope of the present invention, and are obvious from the scope of the patent claims.

It should be noted that the execution procedures for the various processes such as the actions, procedures, steps, and stages in the devices, systems, programs, and methods disclosed in the patent claims, specification, and drawings are not shown in a specific order or priority, and can be performed in any order unless the output of a previous process is used in a subsequent process. With regards to the operation flow in the claims, specification, and drawings, even though descriptions are made using the terms “first”, and “next”, and the like for convenience, this does not mean that the actions must be performed in this order.

1. An information terminal system, comprising:
a processor;
a memory coupled to the processor, wherein the memory comprises instructions for acquiring information from a server based on search condition input by a search performing user and communication results with other information terminals which, when executed by the processor, cause the processor to:
receive input search conditions from the search performing user;
communicate with other information terminals;
transmit a search request to the server based on the input search conditions and the communication results from the other information terminals;
acquire information from the server that matches the input search conditions and the communication results;
customize the acquired information based the communication results with the other information terminals to form customized information; and
display the customized information on the information terminal.

2. The information terminal system according to claim 1, wherein the instructions further cause the processor to:
detecting the other information terminals.

3. The information terminal system according to claim 2, wherein the instructions further cause the processor to:
detect the other information terminals based on positional information and movement information.

4. The information terminal system according to claim 1, wherein the instructions further cause the processor to:
communicate with the other information terminals that are located in proximity to the information terminal system using near distance communication.

5. The information terminal system according to claim 1, wherein the instructions further cause the processor to:
receives attribute information for each user of the other information terminals;
transmit the attribute information and the input search conditions for the search performing user and each of the users of the other information terminals; and
receive the customized information from the server.

6. The information terminal system according to claim 1, wherein the instructions further cause the processor to:
acquire user identification information that each user of the other information terminals use on an Internet;
acquire attribute information for each user of the other information terminals that has been made public on the Internet using the user identification information;
transmit the attribute information and the input search conditions for the search performing user and each user of the other information terminals; and
receive the customized information from the server.

7. The information terminal system according to claim 5, wherein the input search conditions are for searching stores and wherein the instructions further cause the processor to:
acquire the customized information corresponding to the stores from the server.

8. The information terminal system according to claim 5, wherein the input search conditions are for searching a transportation route and wherein the instruction further cause the processor to:
acquire the customized information corresponding to the transportation route from the server.

9. The information terminal system according to claim 7, wherein the instructions further cause the processor to:
receive information including either an address or a current location of each user of the other information terminals as the attribute information from the other information terminals.

10. The information terminal system according to claim 1, wherein the instructions further cause the processor to:
transmit the customized information to the other information terminals.

11. The information terminal system according to claim 1, wherein the instructions further cause the processor to:
acquire the customized information including an estimate of a degree of satisfaction of the search performing user and the users of other information terminals with regards to the customized information for the input search conditions; and
display the estimate of the degree of satisfaction.

12. The information terminal system according to claim 1, wherein the instructions further cause the processor to:
display a plurality of information acquired from the server;
record a history of information selected by the search performing user from the plurality of information that was displayed; and
display information further customized based on the history of information from the customized information acquired from the server.

13. The information terminal system according to claim 12, wherein the instructions further cause the processor to:
record the history of information selected based on a user group that comprises various users of the other information terminals;
search the history of information for a user group that is the same or similar to the user group that comprises the various users of the other information terminals that have communicated while acquiring the customized information; and
display customized information that has been further customized based on the history of the information searched.

14. The information terminal system according to claim 5, wherein the instructions further cause the processor to:
select priority users with priority from the users of the other information terminals;
transmit to the server the input search conditions and the communication results with the other information terminals;
match the input search results;
prioritize the attribute information of the priority user based on the communication result; and
acquire from the server the customized information.

15-20. (canceled)

21. A method, in a data processing system, that acquires information from a server based on search condition input by a search performing user utilizing an information terminal and communication respite with other information terminals, comprising:
receiving input search conditions from the search performing user;
communicating with other information terminals;
transmitting a search request to the server based on the input search conditions and the communication results from the other information terminals;
acquiring information from the server that matches the input search conditions and the communication results;
customizing the acquired information based on the communication results with the other information terminals to form customised information; and
displaying the customized information on the information terminal and the other information terminals.

22. (canceled)

23. A computer program product comprising a computer readable storage medium having a computer readable program stored therein for acquiring information from a server based on search conditions input from a search performing user and communication results with other information terminals, wherein the computer readable program, when executed on an information terminal, causes the information terminal to:
receive input search conditions from the search performing user;
communicate with other information terminals;
transmit a search request to the server based on the input search conditions and the communication results with the other information terminals;
acquire information from the server that matches input search conditions and the communication results;
customize the acquired information based the communication results with the other information terminals to form customized information; and
display the customized information on the information terminal and the other information terminals.

24-25. (canceled)

26. The method of claim 21, further comprising:
receiving attribute information for each user of the other information terminals;
transmitting the attribute information and the input search conditions for the search performing user and each of the users of the other information terminals; and
receiving the customized information from the server.

27. The method of claim 21, further comprising:
acquiring user identification information that each user of the other information terminals use on art internet;
acquiring attribute information for each user of the other information terminals that has been made public on the Internet using the user identification information;
transmitting the attribute information and the input search conditions for the search performing user and each user of the other information terminals; and
receiving the customized information from the server.

28. The method of claim 21, further comprising:
acquiring the customized information including an estimate of a degree of satisfaction of the search performing user and the users of other information terminals with regards to the customized information for the input search conditions; and
displaying the estimate of the degree of satisfaction.

29. The method of claim 21, farther comprising:
displaying a plurality of information acquired from the server;
recording a history of information selected by the search performing user from the plurality of information that was displayed; and
displaying information further customized based on the history of information from the customized information acquired from the server.

30. The computer program product of claim 23, wherein the computer readable program further causes the information terminal to:
receive attribute information for each user of the other information terminals;
transmit the attribute information and the input search conditions for the search performing user and each of the users of the other information terminals; and
receive the customized information from the server.

31. The computer program product of claim 23, wherein the computer readable program further causes the information terminal to:
acquire user identification information that each user of the other information terminals use on an Internet;
acquire attribute information for each user of the other information terminals that has been made public on the Internet using the user identification information;
transmit the attribute information and the input search conditions for the search performing user and each user of the other information terminals; and
receive the customized information from the server.

32. The computer program product of claim 23, wherein the computer readable program further causes the information terminal to;
acquire the customized information including an estimate of a degree of satisfaction of the search performing user and the users of other information terminals with regards to the customized information for the input search conditions; and
display the estimate of the degree of satisfaction.

33. The computer program product of claim 23, wherein the computer readable program further causes the information terminal to:
display a plurality of information acquired from the server;
record a history of information selected by the search performing user from the plurality of information that was displayed; and
display information further customized based on the history of information from the customized information acquired from the server.
